(19) United States
(12) Patent Application Publication
(10) Pub. No.: US 2019/0113536 A1
(43) Pub. Date: Apr. 18, 2019

(54) Flow Measurement Device for a Structure

(71) Applicant: Wind Farm Analytics Ltd, Glasgow (GB)

(72) Inventor: Theodore Cosmo HOLTOM, Glasgow (GB)

(73) Assignee: Wind Farm Analytics Ltd, Glasgow (GB)

(21) Appl. No.: 16/090,520

(22) PCT Filed: Apr. 3, 2017
(86) PCT No.: PCT/GB2017/050933

§ 371 Date: Oct. 1, 2018

(30) Foreign Application Priority Data
Apr. 1, 2016 (GB) 1605535.2

(51) Int. Cl. G01P 5/26; B66C 15/06; G01S 17/58; G01S 17/95; G01S 13/58; G01S 13/95; G01S 15/58; G01S 15/88

(52) U.S. Cl. CPC G01P 5/26; B66C 15/06; G01S 17/58; G01S 15/885; G01S 13/58; G01S 13/953; G01S 15/58; G01S 17/95

(57) ABSTRACT

A crane device comprising: a crane body; and a fluid velocity measurement device comprising a plurality of beam sources arranged such that beams from the beam sources intersect at a measurement point, wherein the measurement device is adapted to measure the velocity of a fluid field approaching the crane body.

### FIELD OF THE INVENTION

The field of the invention is a fluid velocity field measurement system to be employed by structures, buildings or vehicles. The measurements may be used for control systems or advance warning systems. In particular, the use of converging beams allows for three-dimensional fluid field mapping and the identification of extreme fluid flow signatures in advance of impinging the structure, building or vehicle.

### BACKGROUND OF THE INVENTION

A person skilled in the art will appreciate that LIDAR, RADAR, SONAR and SODAR can be used to probe a fluid.

In particular, it will be appreciated that three Doppler beam measurements at the intersection of three non-parallel beams can give a three-dimensional fluid velocity.

It will be appreciated that a system of many beams can simultaneously measure at many locations.

For instance, six beams could be arranged to intersect three beams at each of two measurement locations, or twenty seven beams could be arranged to intersect at nine measurement points, etc. Such beams may or may not be fixed in their orientation.

A means of beam switching, beam scanning or beam steering may be employed in order to direct the beams to intersect at successive different measurement locations. It will be appreciated that if this can be done sufficiently quickly then the time between measurements is insignificant and the set of measurements is effectively a map of the fluid flow at a given point in time. Beam steering towards chosen measurement locations may make use of position and orientation sensors.

It will be appreciated that it is possible to construct a two dimensional, planar map of measurements, or indeed a three dimensional volumetric map of measurements.

It will be appreciated that control systems can make use of such measurement information. A control system may provide warnings and alarms or initiate automatic safety measures, operational shutdown or operational curtailment. A control system may also adapt parameters in order to increase efficiency, reduce loads, increase production or optimise in some other way.

Warnings of gusts, turbulence or other fluid field characteristics could be very useful for aeroplanes wishing to provide their passengers with a more comfortable flight.

Extreme gusts, extreme side winds, down drafts or turbulence at a runway could be dangerous on take off or approach to landing. Therefore, an airfield or airport equipped with intersecting beam LIDAR could offer better safety warnings. Furthermore, intersecting or converging beam LIDAR could give better turbulence measurements than diverging beam LIDAR which has been used at some airfields. The reason is that diverging beam LIDAR implies spatial averaging over a large volume. Converging beam LIDAR offers a local measurement of turbulence, approaching the point-like standard anemometer instrument.

It will be appreciated that LIDAR may employ Continuous Wave (CW) laser or alternatively pulsed laser and that each type has its advantages and disadvantages.

It will be appreciated that there are very many ways in which a structure shape might be adapted. For instance, hydraulic channels can be used. Holes may be opened or closed. Wings or other appendages may be rotated or pitched in angle. Racing car control surfaces could be adjusted in response to wind, such as a side wind, or turbulence, or the slipstream of another car, but also accounting for the relative motion of the car itself. A racing car equipped with advanced LIDAR might know just when the slipstream of the car in front affords most advantage, or when that advantage is reduced, offering improved overtaking opportunity. Downforce produced by a control surface could be adjusted to account for sudden change in relative airflow.

A ship or submarine can set its course more efficiently and respond to changing water currents if equipped with advanced sensors mapping the flow across its hydrodynamic cross section.

In the case of a ship the air flow can also be significant, especially in case of a sailing ship or sailing boat. Therefore, a wind LIDAR which maps the incoming wind, giving time to respond to any changes in wind flow, can offer efficiency advantages. This could be helpful in round the world or long distance yacht races. In case of freight carried by sailing ships LIDAR technology could be very useful. Sailing ship efficiency could be improved, resulting in shorter journey times.

In case of powered shipping within changing fluid flows the look ahead mapping of the fluid flows could allow for look ahead control, more responsive and anticipating the changing conditions rather than responding to them afterwards. This could allow for more efficient, faster shipping.

It will be appreciated that many possible adjustments could be possible in response to the fluid flow measured from a vehicle. Adjustment of vehicle speed, adjustment of vehicle attitude, adjustment of height, and adjustment of depth are all possible.

It will be appreciated that one structure may make measurements which can inform many structures in the vicinity.

It will be appreciated that there are many ways in which structure attitude may be altered. Flying structures or spacecraft may alter their roll, pitch and yaw. A crane structure may rotate out of the wind, or withdraw an extendable arm from its maximum extent. It will be appreciated that many other vehicles and structures may alter their attitude beyond those listed here.

Other control actions could be possible. Active dampers can be adjusted within sky scrapers. It will be appreciated that many control actions could be possible beyond those listed here.

It is considered that a structure may be a fixed structure, or it may be a moveable structure including the possibility that it is a vehicle.

It is considered that any structure, including any vehicle, may be manned (occupied by humans or non-human beings) or unmanned (unoccupied by any live beings).

It will be appreciated that three converging beams may not intersect perfectly at a chosen measurement point in space or time but so long as they converge substantially close to the designated measurement point in space and time then a good measurement may be obtained, which is representative of the perfect or ideal measurement, as if the beams had indeed intersected perfectly at the chosen measurement point in space and time.

It will be appreciated that fluid flow data can be combined with other data in order to learn or analyse what correlations may exist between the fluid flow characteristics and the other characteristics. For example, it could be studied what type of wind field gives rise to greatest movement of a skyscraper. It could be studied what type of volumetric wind field gives rise to greatest down draft accelerations at a given runway, or what kind of wind flow gives rise to greatest wing bending moments.

Human and machine learning or artificial intelligence data analysis may be applied.

Databases of convergent beam measurements data may be gathered from many systems and/or over increasing time periods. Study may be tailored to a specific system, or to families of systems. A learning system may identify beneficial warnings or control parameters. The learning system may continue to improve the warning or control parameters as more data is gathered and analysed within the database, over increasing time and as more measurement systems are deployed to generate data.

It is appreciated that cranes are employed in many commercial and non-commercial environments including but not limited to general construction, skyscraper construction, port and dockside operations, onshore wind turbine installation and offshore wind turbine installation, including floating wind turbine installation.

Apart from construction and installation, cranes may be used for operational maintenance purposes such as wind turbine blade replacement and many other purposes in the wind industry and in other industries such as structural repair, painting or cleaning.

Cranes are often used for loading and unloading materials to or from vehicles, as well as for transferring materials or objects from one part of a plant or facility to another.

It will be appreciated that cranes are often very large structures and can extend to great heights. It is also known that wind speeds are often greater at height compared to ground level. Cranes themselves, as well as their possible suspended loads, present an extended cross sectional area to the wind. Therefore, crane structures, their mounting points and their foundations can all be subject to high wind loading. In the case of very large structures, and in the case of very high winds such as extreme gusts, the loading becomes increased and causes increased fatigue loads during the lifetime of the crane. Furthermore, it could be possible that the loads due to wind conditions could even give rise to catastrophic failure of a crane with or without a suspended load.

Wind conditions could also give rise to motion of a suspended load including swinging of the load about one or more points of suspension. If a suspended load moves due to the wind then it can be possible that the suspended load would collide into the crane structure itself, or into another structure or object. Therefore, it is possible for costly damage to occur due to such collisions.

Therefore, human and material safety considerations can lead crane operators and operations to impose safety limits on crane operations, based on wind conditions. General wind conditions provided by general weather forecasts may be used. Alternatively, a local wind measurement device may be used. It is possible to employ an anemometer such as spinning cup anemometer or ultrasonic device which may be considered “point-like” since they gather wind speed data from a small region in space such as extending a few centimeters. These systems provide measurement data at the measurement point after the wind has reached the point. These systems suffer from being of an invasive nature in that they physically interfere with the wind flow and change the wind that they are measuring. They are not capable of mapping the overall wind conditions since they cannot in themselves provide numerous measurements over an extended mapping region.

Some anemometers such as spinning cup anemometers only offer horizontal wind speed data whereas it is well known that wind velocity is a three dimensional vector quantity and may have a vertical component.

LIDAR systems can measure the wind non-invasively based upon Doppler shift from microscopic aerosols carried on the wind. The LIDAR has a negligible effect on the wind flow it is measuring and can be described as non-invasive. Diverging beam LIDAR and conical scan LIDAR are established methods of LIDAR wind measurement but they suffer from combining information from multiple beams sampling points in space which are greatly separated such as 50 meters apart or even greater. This is generally an incorrect approximation since the wind velocity can vary greatly over 50 meters or more. This fact is familiar to all of us who have seen a tree's branches and leaves moving in the wind and one can see there may be different and even opposite movements from one side of the tree to another.

LIDAR is capable of reconstructing three dimensional wind velocity by measuring three independent line of sight Doppler shifts. By employing converging beams this ensures a three dimensional wind velocity measurement at the point or locale of convergence.

Therefore, converging beam LIDAR can offer an improvement in wind measurement.

Furthermore, it is known that LIDAR wind measurements can be made out to quite long ranges such as one kilometer or even ten kilometers.

Relative and absolute orientation sensors, angle sensors and position sensors may or may not be used in order to correct or adjust a LIDAR beam pointing angle. This may be advantageous in case the beam emanates from a structure, LIDAR mounting point or part of a structure which flexes, moves or bends. Orientation and position sensors could employ various methods such as GPS, differential GPS, magnetometers, gravity sensors, accelerometers, and other methods.

If three LIDAR beams emanate from points which are transversely separated and converge to a measurement point which is far away then the beams will be non-parallel and can be used to reconstruct the three dimensional wind velocity at the measurement point.

Furthermore, it is possible to scan or control the pointing angle of one or more beams such that they converge and measure at a series of points in space. In this way, it is possible to construct a wind velocity component map. By using three or more beams it is possible to produce a fully unambiguous three dimensional wind velocity map. It is also possible to produce such a map by using many groups of three fixed beams arranged so as to converge at many measurement points.

Safety thresholds for crane operations may be defined based on average wind speed over a fixed period such as 1 minute, 10-minute, hourly or another averaging period. Safety thresholds may also be employed based on short term gusts such as average or maximum sample over 5 seconds or some other sampling period. Safety systems may also depend on other parameters used to characterise the wind speed such as turbulence intensity defined by standard deviation of wind speed divided by average wind speed for a given sampling period such as 1-minute, 10-minute or another sampling period.

Apart from simple characterisations of wind field such as wind speeds averaged at a single point in space, more advanced and more informative characterisations of the wind field can be offered. For instance, a system which measures at multiple heights can offer information such as vertical wind shear and vertical wind veer. In general, a 3d mapping system can offer the whole 3d wind velocity map.

It is noted that safety systems with less wind information may fail to achieve safety in the most efficient way. For instance, a safety system which measures wind speed at 10 meters above ground using a spinning cup anemometer may not sense a gust at 100 meters above ground where the top of a crane structure may be subject to intense loading.

It is noted that if a safety system errs too much on the side of caution then crane operations may cease unnecessarily, thereby causing unnecessary economic loss and opportunity loss. For instance, if a safety system works on the basis that wind speed measurement greater than 15 m/s could give rise to incoming damaging wind conditions in the next 5 minutes more than 10% of the time and that this is considered a threshold of unacceptability then the crane operator may always stop crane operations when the wind speed measurement indicates more than 15 m/s. However, a look ahead measurement system which measures 15 m/s close in to the crane may also provide data from far away which shows that the incoming wind speeds are actually reducing below 15 m/s and that there is no need for safety shutdown.

Therefore, a look ahead system can offer greater optimisation of operations. Whereas beforehand the general wind conditions for the site or a general wind forecast for an extended period such as one or many hours could be used to dictate whether operations may continue, after the application of a more capable wind LIDAR measurement system it can be possible to have warnings (for instance a five minute warning of incoming wind) and alarms (for instance a one minute alarm and safety shutdown procedure) in order to dictate whether operations may continue on the basis of specific site conditions. If the wind measurement device providing the wind measurement data samples is located at, nearby or on the crane structure itself and is of point-like type such as spinning cup anemometer then this offers no look ahead or predictive capability. The safety system is therefore reactive.

A wind measurement device offering look ahead mapping of the wind field offers advance warning of potentially dangerous wind conditions. The warning period may depend on incoming wind speed and the measurement range. For instance, wind speed features moving inward at 120 km per hour which are measured 2 kilometers away can be measured one minute in advance.

A crane can be a fixed crane mounted on the ground. A crane can also be a mobile unit, having wheels. A crane may be on rails, mounted on a railway carriage or mounted on a train. A crane can be towed or self-propelled. A crane can be fixed or mounted to a vehicle such as a ship or a jack up vessel as used for offshore wind turbine installation.

A crane can be telescopic. A crane can have one or more arms. A crane can have one or more cantilevers. A crane may include one or more counter weights. A crane can incorporate extending legs for stability during deployment.

A crane can be a climbing crane such as a wind turbine tower climbing crane. A crane may be fixed in place by use of gravitational stable equilibrium, friction, compressive grip or other means.

A crane can incorporate a hook, a loop, a magnetic pick up or other types of fixing equipment.

A crane may incorporate electric drive systems, hydraulic drive systems, hydraulic motors, cable winches, propulsion engines and electric propulsion systems.

A crane may include a cab or housing for one or more human operators, or alternatively a crane may be remotely controlled.

### SUMMARY OF THE INVENTION

According to a first aspect of the present invention there is provided a crane device in accordance with the appended claims.

The invention may also comprise one or more of the following:

A system comprising a plurality of beams emanating from a structure such that two or more beams converge toward a measurement point.

The system where the structure is situated within a fluid such as air, ionic flow, solar wind, planetary atmosphere, gas, seawater or fresh water.

The system where the converging beams are LIDAR beams

The system where the converging beams are RADAR beams

The system where the converging beams are SODAR beams

The system where the converging beams are SONAR beams

The system where the Doppler effect or frequency shift is employed in order to resolve the radial velocity of scattering particles or substance within the fluid

The system where the velocity of the scattering particle or substance at a given measurement point is indicative of the overall fluid flow at that measurement point and in its close vicinity

The system where the radial velocities measured by two or more beams are combined in order to give a two dimensional flow velocity

The system where the radial velocities measured by three or more beams are combined in order to give a three dimensional flow velocity

The system where the radial velocities measured by N or more beams are combined in order to give an N-dimensional flow velocity where N is greater than three.

The system where successive velocity measurements are differentiated in order to produce an acceleration measurement, in case fluid acceleration attributes are interesting as well as fluid velocity field attributes

The system where successive acceleration measurements are differentiated in order to produce the next time derivative, and so on to obtain higher time derivatives of the velocity field

The system where means of beam switching, beam steering or beam scanning is employed in order to direct the beam towards a chosen measurement point.

The system where a plurality of intersecting beam measurements is made at different points in space and/or time

The system where the plurality of measurements is combined into a map illustrating the variation of the three-dimensional fluid velocity field, where such map may be a visual depiction or alternatively a numeric set, or both.

The system where the structure is a fixed structure such as residential building, commercial building, skyscraper, industrial plant, statue, antenna mast, warehouse, electricity transmission pylon, viaduct, aqueduct or bridge.

The system where the structure is a crane. The system where the structure is a runway, landing strip or aircraft carrier.

The system where the structure is a floating structure such as oil rig, floating data centre, barge or floating terminal.

The system where the structure is an aerial vehicle such as aeroplane, sea-plane, air ship, helicopter, balloon, drone, unmanned aerial vehicle, glider. The system where the structure is a space vehicle such as solar sail, space shuttle, satellite, space station, rocket, hypersonic plane or scramjet. The system where the structure is a ground-based vehicle such as cargo lorry of any type, truck, mobile plant, tanker lorry of any type, car, bus, racing car.

The system where the structure is a water borne vehicle such as cruise ship, cargo ship, gas tanker, chemical tanker, ferry, hydrofoil, yacht, catamaran or other multi-hulled vessel, ice breaker, lifeboat or other vessel.

The system where the structure is a submarine, diving bell, remotely operated underwater vehicle or a semi-submersible craft.

The system where the structure or vehicle is manned or occupied by humans or other live creatures, and may be operated by humans or other live creatures, or else operated by remote control, automatic guidance system or guided by artificial intelligence.

The system where the structure or vehicle is unmanned, autonomous, remotely operated, guided by an automatic system or guided by artificial intelligence.

The system where measurement data is employed to give warning or alarm of incoming fluid field attributes such as extreme wind gusts, sudden changing wind, turbulence, whirlpools, eddies, updraft, downdraft

The system where individual convergent beam measurements, or sets of convergent beam measurements, or warnings based thereof, are employed as inputs into a control system

The system where a control system adjusts the structure shape in response to one or more convergent beam measurement

The system where a control system adjusts flaps or adaptive surfaces on a wing, aerodynamic surface, hydrodynamic surface or other surface in response to one or more convergent beam measurement

The system where a control system adjusts vehicle speed in response to one or more convergent beam measurement

The system where a control system adjusts structure attitude in response to one or more convergent beam measurement

The system where a control system adjusts the flight path, marine trajectory, submarine trajectory or other locus of motion in response to one or more convergent beam measurement

The system where the control purpose includes increased efficiency of trajectory.

The system where the control purpose includes increased comfort.

The system where the control purpose includes increased safety.

A measurement method comprising emitting beams from a plurality of sources such that beams from the measurement sources intersect at a measurement point, receiving Doppler shifts of reflected or scattered beams, and determining a fluid velocity at the measurement point based upon the Doppler shifts; wherein each of the plurality of beam sources is mounted on a building or on a vehicle.

This method comprising carrying out steps for implementing the systems described above.

Any kind of computer software to implement any of the aforementioned measurement systems, or carrying out any of the aforementioned methods.

Any kind of computer software to implement any of the aforementioned control systems.

Any machine learning system which combines convergent beam measurement data with other data in order to learn or analyse what kind of fluid flow characteristics give rise to, or are correlated with, other types of data.

Any combination of the above systems and or methods.

### BRIEF DESCRIPTION OF THE DRAWINGS

FIG. 1 shows a car, in this example a racing car, where three converging Doppler LIDAR beams are employed to measure the relative air velocity.

FIG. 2 shows a ship, in this example a sailing ship, where three converging Doppler LIDAR beams are employed to measure the relative wind velocity.

FIG. 3 shows an aircraft, in this example a passenger air liner, where three converging Doppler LIDAR beams are employed to measure the relative wind velocity.

FIG. 4 shows a structure, in this example a sky scraper or tall building, incorporating an active mass damper system which is adjusted in response to measurement of the incoming wind characteristics.

FIG. 5 shows a structure which is a crane, where Doppler LIDAR beams are employed to measure the wind conditions surrounding the crane enabling look ahead prediction of incoming wind conditions.

### DETAILED DESCRIPTION OF THE DRAWINGS

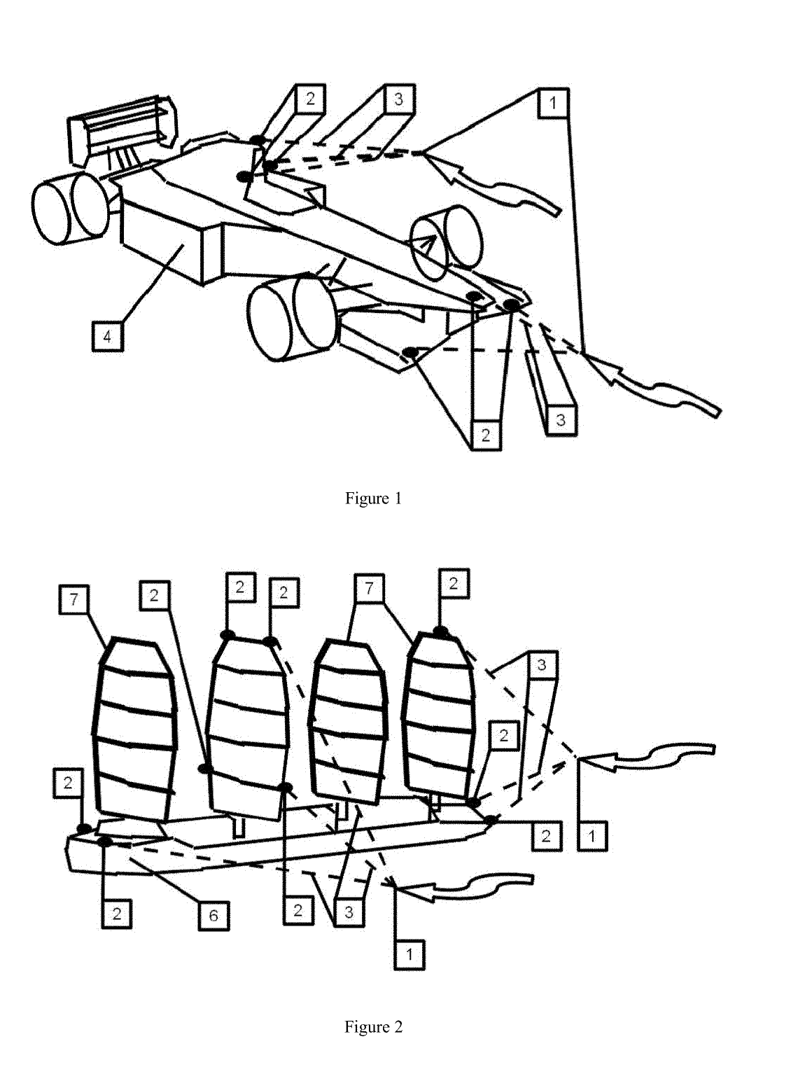

FIG. 1 shows a car, in this example a racing car 4, where a plurality of converging Doppler LIDAR beams 3, emanating from a plurality of LIDAR sources 2, are employed to measure the relative air velocity at a measurement point 1.

FIG. 2 shows a ship, in this example a sailing ship 6 including one or many sails 7, where three converging Doppler LIDAR beams 3, emanating from a plurality of LIDAR sources 2, are employed to measure the relative air velocity at a measurement point 1.

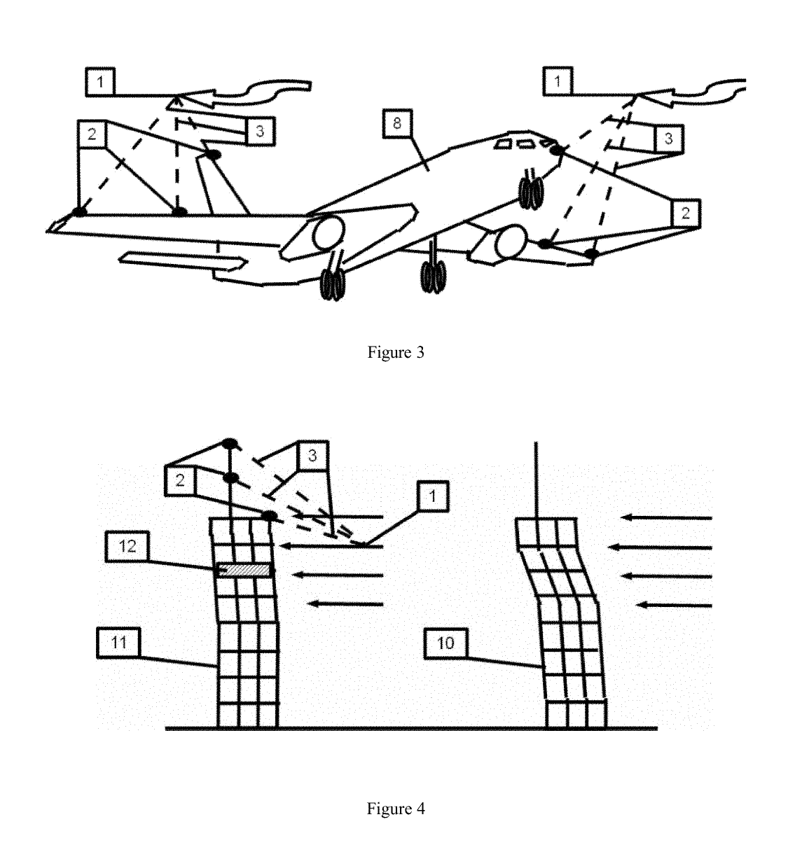

FIG. 3 shows an aircraft, in this example a passenger air liner 8, where three converging Doppler LIDAR beams 3, emanating from a plurality of LIDAR sources 2, are employed to measure the relative air velocity at a measurement point 1.

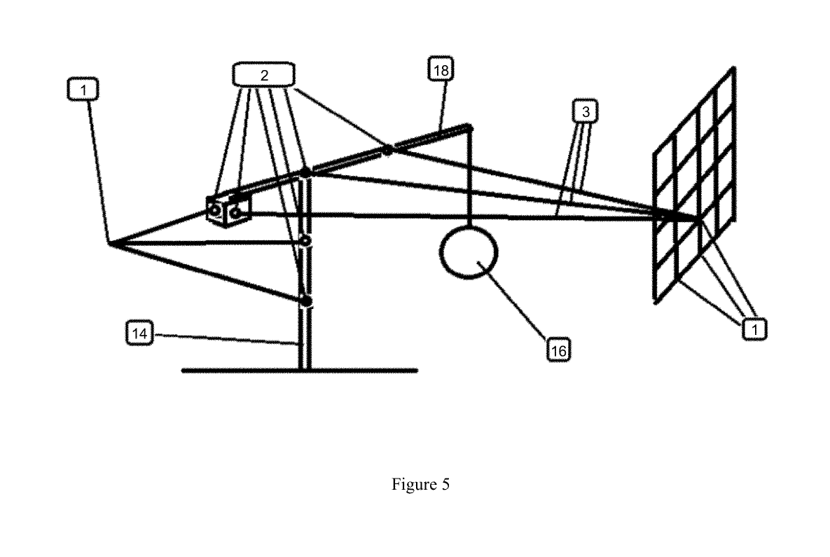

FIG. 4 shows a structure, in this example a sky scraper or tall building 11, incorporating an active mass damper system 12 which is adjusted in response to measurement of the incoming wind characteristics, where three converging Doppler LIDAR beams 3, emanating from a plurality of LIDAR sources 2, are employed to measure the wind velocity at a measurement point 1. An equivalent structure 10, not incorporating such a LIDAR system combined with active damper system may suffer greater deformation and stress. It will be appreciated that many different mounting arrangements and structures are possible.

FIG. 5 shows a crane 14, with a load 16 suspended from an arm or cantilever 18. On the crane are mounted one or many LIDAR sources 2, which point at one or many measurement points 1 with their LIDAR beams 3. Three non-parallel beams can be made to converge at a wind measurement point 1 in order to locally measure the three-dimensional wind velocity vector, and many such measurements can form a wind field map covering an extended region of space and allowing for look ahead warning of particular chosen wind signatures.

The figures show a small selection of examples.

1. A crane device comprising:
a crane body; and
a fluid velocity measurement device comprising a plurality of beam sources arranged such that beams from the beam sources intersect at a measurement point.

2. A crane device according to claim 1, wherein the measurement device is adapted to measure one or more velocities from within a fluid field approaching the crane body; and/or to measure a parameter derived from the one or more measured velocities; and optionally to activate an alarm when the parameter is greater than a predetermined threshold.

3. (canceled)

4. A crane device according to claim 2, wherein the parameter comprises a vertical wind shear defined as the difference between the velocity of the fluid at a first height and a second height; and/or a load calculated from the one or more measured velocity.

5. A crane device according to claim 1, including a control system which is responsive when the measured velocity or a parameter derived from at least one measured velocity is greater than a predetermined threshold.

6. A crane device according to claim 5, wherein the control system is adapted to provide warnings and/or alarms or initiate automatic safety measures, operational shutdown or operational curtailment; or to vary parameters in order to increase efficiency, reduce loads, increase production or optimise operation.

7. (canceled)

8. A crane device according to claim 5, wherein the control system comprises an autonomous manoeuvring device, and wherein the autonomous manoeuvring device is activated when the measured velocity or a parameter derived from the measured velocity is greater than a predetermined threshold.

9. A crane device according to claim 8, including a retractable and/or rotatable crane arm, and wherein the autonomous manoeuvring device is adapted to retract and/or rotate the crane arm when the measured velocity or a parameter derived from the measured velocity is greater than a predetermined threshold; and/or to adjust one or both of the position and orientation of the crane body when the measured velocity or a parameter derived from the measured velocity is greater than a predetermined threshold.

10. (canceled)

11. A crane device according to claim 8, wherein the autonomous manoeuvring device is adapted to raise or lower a carried load when the measured velocity or a parameter derived from the measured velocity is greater than a predetermined threshold.

12. A crane device according to claim 8, including a locking device adapted to lock a component of the crane device relative to the crane body, and wherein the autonomous manoeuvring device is adapted to activate the locking device when the measured velocity or a parameter derived from the measured velocity is greater than a predetermined threshold.

13. (canceled)

14. (canceled)

15. A crane device according to claim 1, wherein the measurement device is adapted to measure a velocity of the fluid field at a first region near to the crane body and at a second region remote from the crane body to determine if the velocity is increasing, decreasing or remaining constant.

16. A crane device according to claim 1, wherein the beam sources comprise LIDAR beam sources, RADAR beam sources, SODAR beam sources, or SONAR beam sources.

17. (canceled)

18. (canceled)

19. (canceled)

20. A crane device according to claim 1, wherein the measurement device utilises the Doppler effect or frequency shift to resolve the radial velocity of scattering particles or substance within the fluid.

21. (canceled)

22. A crane device according to claim 20, wherein the radial velocities measured by two or more beams are combined in order to give a two dimensional flow velocity; the radial velocities measured by three or more beams are combined in order to give a three dimensional flow velocity; or the radial velocities measured by N or more beams are combined in order to give an N-dimensional flow velocity, where N is greater than three.

23. (canceled)

24. (canceled)

25. A crane device according to claim 1, wherein acceleration or other time derivative measurements of successive velocity measurements are obtained.

26. (canceled)

27. (canceled)

28. A crane device according to claim 1, wherein beam switching, beam steering or beam scanning is employed in order to direct one or more beams towards a chosen measurement point.

29. A crane device according to claim 1, wherein a plurality of intersecting beam measurements are made at different points in space and/or time.

30. A crane device according to claim 29, wherein the plurality of measurements are combined into a map illustrating the variation of the three-dimensional fluid velocity field, wherein such map may be a visual depiction or a numeric set or both.

31. A crane device according to claim 1, wherein measurement data is employed to identify incoming extreme wind gusts, sudden changing wind, turbulence, whirlpools, eddies, updraft or downdraft.

32. A method of operating a crane device having a crane body, the method comprising:
providing a measurement device at the crane body, the measurement device comprising a plurality of beam sources arranged such that beams from the beam sources intersect at a measurement point; and
measuring a fluid velocity using the measurement device.

33. (canceled)

34. (canceled)

35. A non-transitory computer program providing a crane device control system which is arranged to receive readings from a plurality of beam sources arranged such that beams from the beam sources intersect at a measurement point; and to measure a fluid velocity based on the received readings.
